(19) United States
(12) Patent Application Publication
(10) Pub. No.: US 2001/0011688 A1
(43) Pub. Date: Aug. 9, 2001

(54) Drilling fluid mixing apparatus and methods

(76) Inventors: Blake Whitlatch, Mandeville, LA (US); Larry J. Smith, Baton Rouge, LA (US)

Correspondence Address: SIEBERTH & PATTY, 2924 BRAKLEY DRIVE SUITE A 1, BATON ROUGE, LA, 70816

(21) Appl. No.: 09/805,543

(22) Filed: Mar. 13, 2001

Related U.S. Application Data
(63) Continuation of application No. 09/395,849, filed on Sep. 14, 1999, now abandoned.
Application No. 09/395,849 is a continuation of application No. 09/064,113, filed on Apr. 21, 1998, now abandoned.

(51) Int. Cl. B02C 19/12

(52) U.S. Cl. 241/21; 241/101.8

(57) ABSTRACT

Methods and apparatus for mixing two or more drilling fluid components to form a drilling fluid composition. In one embodiment, a method is provided which comprises (a) combining the components in a substantially sealed mixing tank to form a mixture, at least one of the drilling fluid components being dispensed under substantially sealed and externally dust-free conditions from at least one bulk bag into the tank, (b) agitating the mixture within the mixing tank, and (c) circulating at least a portion of the mixture from the mixing tank through grinding means for breaking apart agglomerates within the mixture.

### REFERENCE TO RELATED APPLICATIONS

This is a continuation of commonly-owned copending application Ser. No. 09/395,849, filed Sep. 14, 1999, which is a continuation of commonly-owned application Ser. No. 09/064,113, filed Apr. 21, 1998, now abandoned.

### TECHNICAL FIELD

This invention relates to commercial scale apparatus and methods for mixing components to make fluid compositions, and especially to make drilling fluids useful in oil exploration.

### BACKGROUND

Conventional oil well drilling requires the use of large volumes of drilling fluids, also conventionally known as drilling muds. These fluids are called upon to perform a number of tasks when in use. For example, conventional drilling operations typically depend upon drilling fluids to convey drill cuttings out of the well bore, suspend drill cuttings while quiescent, control subsurface formation pressures, isolate the fluids from the surrounding formations, maximize the drill bit penetration rate, lubricate and cool the drill bit, control rates of corrosion, and protect the surrounding formation from becoming sealed to enable removal of hydrocarbons as desired. The delays and cost overruns at drill sites resulting from drilling fluids which perform inadequately are proportionate with drilling depths. Hence, as drilling depths increase, so too does the importance of drilling fluids that perform as intended. The preparation of drilling fluids can have a direct effect on their performance at the well site and, in turn, a direct effect upon profits realized from the subject well. Yet, methods of drilling fluid preparation at well sites have changed little over the past several years. In offshore drilling operations, the most common mixing method still employs manual labor to empty sacks of drilling fluid components into a hopper to make an initial drilling fluid composition. When recycling drilling fluid compositions which contain drill cuttings, screen shakers are then employed to remove undesired solids. However, because of agglomerates formed as a result of inadequate mixing during initial production of the drilling fluid composition, such screen shakers unnecessarily filter out as much as thirty percent of the initial drilling fluid components from the recycled drilling fluid composition prior to its reuse or storage for later reuse. These conventional methods are inefficient and often result in an incomplete mix of the drilling fluid components. The resulting fluids often fail to meet laboratory specifications and as a result fail to perform as intended during the drilling process. The conventional methods also are wasteful in that they produce large amounts of solid waste which must be disposed of, and they require the use of excess amounts of fluid components to produce the desired amount of a properly mixed drilling fluid composition. In addition, the manual labor required to empty hundreds or thousands of sacks of material in conventional methods is fraught with health and safety risks, as well as financial costs for drill operators.

A need therefore exists for methods and apparatus which enable the efficient, large-scale production of properly mixed drilling fluids at oil well drill sites, including offshore drilling rigs.

### SUMMARY OF THE INVENTION

This invention is deemed to satisfy this need in a highly effective manner. In one embodiment of this invention, a method of mixing two or more drilling fluid components to form a drilling fluid composition is provided. The method comprises:

(a) combining the components in a substantially sealed mixing tank to form a mixture, at least one of the drilling fluid components being dispensed under substantially sealed and externally dust-free conditions from at least one bulk bag into the tank,

(b) agitating (e.g., by shaking, stirring, sifting) the mixture within the mixing tank, and

(c) circulating (e.g., by feeding, draining, pumping) at least a portion of the mixture from the mixing tank through grinding means for breaking apart agglomerates within the mixture. This method is especially effective when mixing a drilling fluid component, e.g., a polymer, which is not readily soluble with the other drilling fluid component(s) and therefore tends to clump or form agglomerates during the mixing process. Preferably, the component which is dispensed from the bulk bag into the tank is dispensed at a rate of at least about 2 cubic feet per minute, more preferably at a rate of at least about 10 cubic feet per minute. At least two of the drilling fluid components preferably are concurrently dispensed into the tank from respective bulk bags under substantially sealed and externally dust-free conditions.

A method of mixing two or more drilling fluid components to form a drilling fluid composition is provided in another embodiment of this invention. The method comprises:

(a) combining the components in a substantially sealed mixing tank to form a mixture, at least one of the drilling fluid components being dispensed under pressure and under substantially sealed and externally dust-free conditions into the tank and at a rate of at least about 8 cubic feet per minute, and

(b) agitating (e.g., by shaking, stirring, sifting) the mixture within the mixing tank so that the mixture has an average particle diameter no greater than about 10 times (more preferably no greater than about 4 times, most preferably no greater than about 1 times) the greater (2 components) or greatest (3 or more components) of the average particle diameters of the drilling fluid components.

This method is especially effective when mixing fluid components which are more readily soluble with the other fluid component(s) and do not require additional mechanical energy to break apart agglomerates in order to obtain a sufficiently homogenous composition (e.g., barite). Preferably, the rate in (a) is at least about 13 cubic feet per minute, and more preferably at least about 21 cubic feet per minute. As with the other methods of this invention, this method may be conducted as either a batch or continuous process. When conducted in batch, it is preferred that the steps of this method be conducted in a total period of time which is no greater than about 30 minutes, more preferably no greater than about 15 minutes, and most preferably no greater than about 10 minutes.

This invention also provides an apparatus for mixing two or more drilling fluid components at an oil well drill site to produce a drilling fluid composition. The apparatus comprises:

a) a substantially sealed mixing tank;

b) agitating means for agitating a mixture within the mixing tank;

c) at least one receiving means for receiving a bulk bag and conveying the contents of the bulk bag into the tank, the receiving means being capable of conveying the contents of the bulk bag at a rate of at least about 2 cubic feet per minute; and

d) grinding means for breaking apart glomerate material within the mixture while at least a portion of the mixture circulates through the grinding means.

Yet another embodiment of this invention provides for an offshore drilling rig which comprises:

a) a platform suspendable above sea level;

b) a substantially sealed mixing tank;

c) agitating means for agitating a mixture within the mixing tank;

d) at least one receiving means for receiving a bulk bag which contains at least one mixture starting component and for conveying the contents of the bulk bag into the tank, the receiving means being capable of conveying the contents of the bulk bag at a rate of at least 2 cubic feet per minute;

e) grinding means for breaking apart agglomerates within the mixture while at least a portion of the mixture circulates through the grinding means; and

f) a conduit for transporting the mixture from the mixing tank to a desired location.

With respect to the methods of this invention, it is particularly preferred that the method steps be conducted on an offshore oil well drilling platform (also referred to in this description and in the appended claims as an offshore oil rig). In this way, drilling fluid compositions of laboratory specification quality may be rapidly and safely produced at the well site to take full advantage of the features of the methods and apparatus of this invention.

These and other embodiments and features of the invention will become still further apparent from the ensuing description, appended claims and accompanying drawings.

### BRIEF DESCRIPTION OF THE DRAWINGS

FIG. 1 is a schematic diagram of a preferred embodiment of this invention including a top plan view of the mixing tank with the top of the tank made transparent for illustration purposes.

FIG. 2 is another schematic diagram of the embodiment of FIG. 1 including a side cross-sectional view of the mixing tank.

FIG. 3 is an elevated view in perspective of another preferred embodiment of this invention, partially broken away.

In each of the above figures, like numerals are used to refer to like or functionally like parts among the several figures.

### DETAILED DESCRIPTION OF THE INVENTION

As may now be appreciated, the present invention provides a highly efficient method and apparatus for rapidly mixing drilling fluid components to produce, even at an offshore drilling site, large quantities of drilling fluids that are substantially homogeneously mixed and have low average particle diameter, when desired. Moreover, the present invention provides these advantages without producing the large amounts of solid waste or the hazardous environmental and work conditions typically associated with convention methods and apparatus.

The drilling fluid components which are combined in the methods and by the apparatus of this invention may be solids or liquids. Typically, at least one solid component and at least one liquid component, or two or more different liquid components, are mixed together by the methods and/or apparatus of this invention to form a liquid composition. Suitable water-sensitive components can include, for example, calcium hydroxide, sodium hydroxide, sodium carbonate, sodium bicarbonate, potassium hydroxide, calcium sulphate, organic thinner/modified tannin, lignosulfonate, lignite, sodium acid pyrophosphate, calcium lignosulfonate, partially hydrolyzed polyacrylamide, bacterial gums, polysaccharide, polyanionic cellulose, carboxylmethyl cellulose, polysaccharides, hydroxyethyl cellulose, sulfonated lignite co-polymers, asphalt, sulfonated asphaltines, gilsonite, and the like, including mixtures thereof. Other suitable, less water-sensitive components include, for example, barite, bentonite, hematite, gel, salt gel, sodium chloride, walnut shells, cylicates, peanut shells, spun rock, coke, Kwik-Seal® (comprised on granules, flakes and fibers), and the like, including mixtures thereof. Water itself may also serve as a component to the drilling fluid composition. The components and their relative amounts will vary widely depending upon the particular application for which the resulting composition will be employed.

In the practice of this invention, at least one of the components is dispensed from a bulk bag. Such components typically will be solid particulate material. Suitable bulk bags are typically fabricated from synthetic polymers and/or plastics, although any resilient but non-rigid material may be used. Suitable bulk bags may also include a liner made of plastic or other water-resistant, flexible sheet material to protect the contents of the bag. Suitable bulk bags preferably can carry as much as about 30 or more, more preferably about 70 or more, and most preferably about 100 or more, cubic feet of material. In a particularly preferred embodiment, the bulk bag employed has a capacity of about 125 cubic feet.

The more rapid the rate of dispensation of material from the bulk bags, the more efficient the mixing process in commercial scale applications. In the methods of this invention, the component being dispensed from the bulk bag is dispensed preferably at a rate of at least about 2 cubic feet per minute, even more preferably at a rate of at least about 6 cubic feet per minute, and most preferably at a rate of at least about 10 cubic feet per minute. When pressure is applied in the methods of this invention to dispense a solid particulate component for addition to a mixture, the pressure preferably is in the range of at least 10 psig, and more preferably at least 30 psig. In any event, components dispensed under pressure are preferably dispensed into the tank at a rate of at least about 8 cubic feet per minute, more preferably at a rate of at least about 13 cubic feet per minute, and most preferably at a rate of at least about 21 cubic feet per minute. Use of such rates of dispensation and pressures enables the rapid production of the desired fluid composition and the most efficient utilization of resources at the well drilling site.

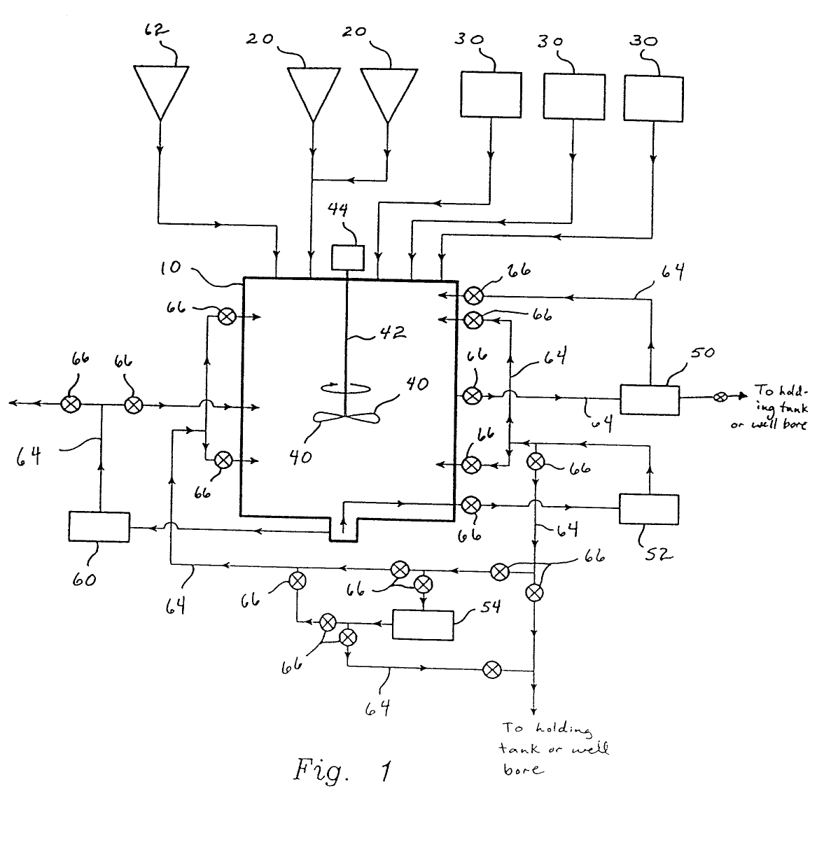

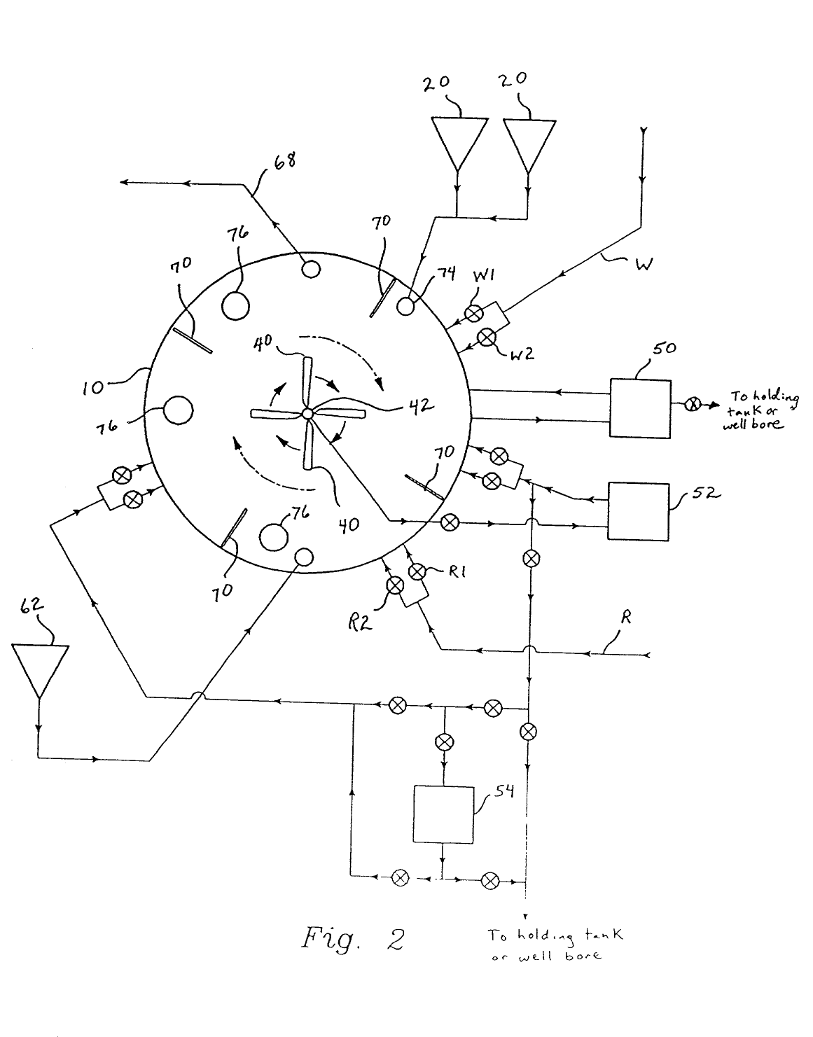

Referring now to the drawings, FIGS. 1 and 2 schematically illustrate a mixing system employing preferred apparatus of this invention. The preferred apparatus depicted comprises a substantially sealed, cylindrical mixing tank 10 the longitudinal axis of which is substantially vertically disposed, a plurality of transportable pressurized silos 20, a plurality of bulk bag support and receiver apparatus 30, agitating means in the form of a plurality of mixing paddles 40 disposed within tank 10 and extending radially from an end portion of a rotary shaft 42 which in turn is connected at its opposite end portion to and rotated by a motor 44, and grinding means in the form of a sheering pump 50. As depicted, the apparatus further includes a primary transfer pump 52, a secondary sheering pump 54, and a sump pump 60. Components to be mixed together generally are introduced to tank 10 when dispensed under substantially sealed and externally dust-free conditions from silos 20 and from bulk bags contained by support means and receiving means in the form of support and receiver apparatus 30. In this regard, and as used throughout this specification and the appended claims substantially sealed means no significant amount of the liquid or solid particulate material within is lost to the surrounding environment through leakage, excessive evaporation, etc. Preferably, water-sensitive components are introduced through silos 20, while less water-sensitive components are dispensed from bulk bags via apparatus 30. In the preferred embodiment depicted, silos 20 are pressurized using an inert gas and are otherwise as described in U.S. Pat. No. 5,303,998 to Whitlatch et al. Additional components or compositions to be mixed may be introduced from a separate reservoir via conduit R through an upper valve R1 and/or a lower valve R2. Likewise, water may be introduced to tank 10 via a water conduit W through an upper valve W1 and/or a lower valve W2. In addition, in the preferred embodiment depicted, additional solid particulate material may be pneumatically transferred into tank 10 from a separate pressurized storage tank 62.

It should be noted that FIG. 1 and FIG. 2 differ in that FIG. 1 does not illustrate all inlets through which material may be added to the mixing tank, but rather schematically illustrates the vertical position of all inlets and outlets which are in liquid communication with any of silos 20, support and receiver apparatus 30, or pumps 50, 52, 54 or 60. In addition, pump 60 and its associated conduits and valves are only illustrated on FIG. 1. Pumps 50, 52, 54 and 60 are connected to one another and to tank 10 via a network of conduits 64 and a plurality of valves 66 to provide a number of options for directing the flow of the mixture into and out of the tank and from the tank to, for example, one or more secondary tanks or the well bore. As may be seen with reference to FIG. 2, certain conduits feed into the tank via an upper inlet and a lower inlet. This feature enables the addition of compositions and/or components to the tank in a variety of different ways and at a variety of different rates to maximize the rate of mixing and the quality of the end product. In addition, liquids which tend to foam when splashed into the tank may be fed or recirculated into the tank via a lower inlet, thereby enabling subsurface addition to minimize or eliminate foaming.

Since some components may be introduced into tank 10 while under pressure, and since the apparatus as a whole may be substantially sealed, tank 10 is also provided with pressure vent line 68 which extends out from the top of tank 10. Components introduced to tank 10 form a mixture which is agitated therein and/or circulated through the associated pumps and back into the tank. During agitation within tank 10 when mixing paddles 40 are in motion, the mixture flows in the direction of the arrows on FIG. 2, and around a plurality of substantially vertical baffles 70 which extend from the inner surface of tank 10 inwardly and extend vertically from a point proximate to the bottom of tank 10 to the upper portion of tank 10. Baffles 70 disrupt the mixture flow, thereby further agitating the mixture while mixing paddles 40 are in motion. Simple circulation out of and back into tank 10 is useful particularly when the various components added to the mixture within tank 10 have different specific gravities or it is otherwise desirable to remove settled material from tank 10 and to feed it back into the tank at an upper portion thereof. Circulation through sheering pump 50 may also be desirable when the breakup of agglomerates formed within the mixture in tank 10 is desirable. The various conduits 64 and valves 66 enable single pass circulation of the mixture through pump 50, or a loop-type recirculation through pump 50 so that the mixture makes several passes to insure adequate breakup of agglomerates. Once the mixing is complete, the resulting drilling fluid composition may be stored in tank 10 for later use, or it may be pumped out tank 10 and to a desired location, such as, e.g., either a separate holding tank or to the well bore.

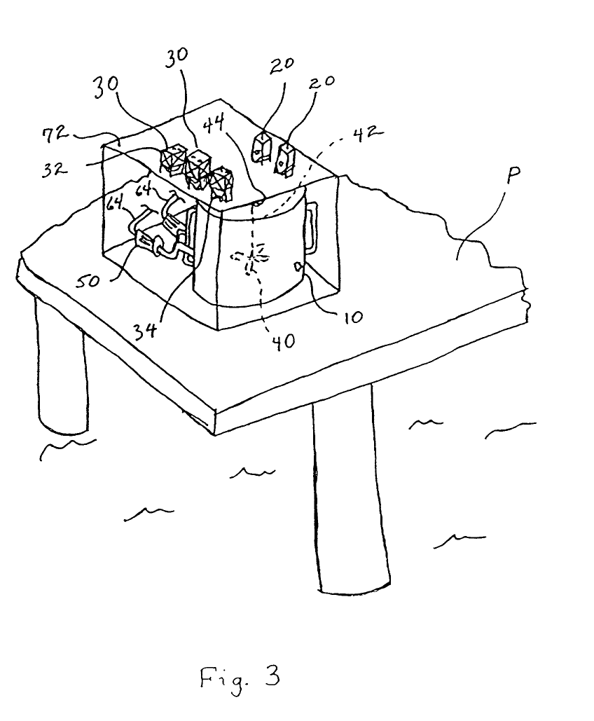

FIG. 3 illustrates a preferred offshore oil rig of this invention, partially broken away. As depicted there, the device of FIGS. 1-2 is part of an offshore oil rig which comprises a platform P which is elevated above sea level, tank 10, agitating means in the form of mixing paddles 40 disposed within tank 10 and extending radially from rotary shaft 42 which in turn is connected at its opposite end portion to and rotated by motor 44, a plurality of receiving means in the form of support and receiver apparatus 30 for receiving bulk bags which contain solid particulate starting components and for conveying the contents of the bulk bags into tank 10. The receiving means depicted should be capable of conveying the contents of the bulk bag at a rate of at least 2 cubic feet per minute. It will be appreciated that support and receiver apparatus 30 and silos 20 are supported above tank 10 by a support structure 72, so that materials dispensed from silos 20 flow through a flexible conduit extending through support structure 72 and through the top of tank 10 via a port 74 illustrated in FIG. 2, while materials dispensed from apparatus 30 flow through flexible conduits extending through support structure 72 and through the top of tank 10 via a plurality of respective ports 76 illustrated on FIG. 2. The rig further includes grinding means in the form of sheering pump 50 for breaking apart agglomerates within the mixture while at least a portion of the mixture circulates therethrough, and two conduits 64 for transporting the mixture from tank 10 to a desired location, e.g., the well bore or a secondary holding tank or reservoir. Preferably, all of the conduits which extend between tank 10 and the pumps, silos and support and receiver apparatus of this invention are flexible, so that tank 10 may be accurately weighed by one or more scales disposed between support structure 72 and the bottom of tank 10.

Support and receiver apparatus 30 preferably is comprised of separate collapsible support apparatus 32 and receiver apparatus 34, both of which are described in greater detail in commonly assigned U.S. patent application Ser. No. 09/064,115 filed on Apr. 21, 1998. This particularly preferred support and receiver apparatus facilitates the efficient transportation and externally dust-free transportation dispensation of large amounts of solid particulate component material for use in preparation of the drilling fluid compositions.

The agitating means in apparatus of this invention may be comprised of any device capable of agitating a liquid mixture. Suitable non-limiting examples of such devices include mechanical stirring devices, blenders, shakers, aeration devices, jet-propulsion devices, and the like, including combinations of any two or more of the foregoing. Preferably, the agitating means is a motorized blender comprised of a plurality of a plurality of blades extending radially from an end portion of a substantially vertical drive shaft which extends into the tank and which is connected at the opposite end portion to a motor which rotates the shaft. When present in apparatus of this invention, the grinding means may be comprised of any mechanical device which acts to break apart agglomerates in a liquid mixture. Suitable examples of such a device include shaker screens, augers, high-speed rotary grinders, etc. However, the grinding means preferably comprises a pump configured to apply a sheering force to the portion of the mixture circulated through the pump, thereby causing the mixture to become substantially homogeneous such that the average particle diameter of the mixed composition at least approximates laboratory dimensional specifications for the particular composition involved. Examples of such pumps are described in one or more of U.S. Pat. Nos. 5,302,082, 3,544,138, 3,420,456 and 3,375,983. A particularly preferred pump is commercially available as the Mega-Grinder model from Arde Barinco Inc. of Norwood, N.J.

In the methods of this invention, it will now be appreciated by those of ordinary skill in the art that the step of agitating the mixture within the mixing tank may be accomplished in a number of different ways, such as, e.g., by mechanically or electromechanically shaking the tank, stirring its contents, or sifting its contents, but that agitation is preferably accomplished as described and depicted above. Likewise, those of ordinary skill in the art will now appreciate that the step of circulating at least a portion of the mixture from the mixing tank through grinding means for breaking apart agglomerates within the mixture may be accomplished in a number of different ways, such as, e.g., by mechanically or electromechanically feeding, draining, or pumping the mixture through the grinding means, but that circulation is preferably accomplished as described and depicted above.

It is to be clearly understood and appreciated that in the specification and claims hereof, all references to components used relate to the initial identity of the component being used, and such references do not in any way require that during the methods the components must maintain that identity until the instant, if any, that a chemical transformation occurs to form a different substance. In short, once two or more of the identified components are brought into contact with or proximity to each other, whether under reaction conditions or not, one or more of them may undergo a change in identity as compared to their original identity, and such change or changes are encompassed by the claims hereof as long as the end results of the overall methods are as described herein.

The disclosure of each patent and patent application referenced above is incorporated herein by reference to the fullest extent permitted by applicable law.

This invention is susceptible to considerable variation in its practice. Therefore, the foregoing description is not intended to limit, and should not be construed as limiting, the invention to the particular exemplifications presented hereinabove. Rather, what is intended to be covered is as set forth in the ensuing claims and the equivalents thereof permitted as a matter of law.

What is claimed is:

1. A method of mixing two or more drilling fluid components to form a drilling fluid composition, the method comprising:
(a) combining the components in a substantially sealed mixing tank to form a mixture, at least one of the drilling fluid components being dispensed under substantially sealed and externally dust-free conditions from at least one bulk bag into the tank,
(b) agitating the mixture within the mixing tank, and
(c) circulating at least a portion of the mixture from the mixing tank through grinding means for breaking apart agglomerates within the mixture.

2. A method according to claim 1 wherein the component being dispensed from the bulk bag into the tank is dispensed at a rate of at least about 2 cubic feet per minute.

3. A method according to claim 2 wherein the rate is at least about 10 cubic feet per minute.

4. A method according to claim 1 wherein at least two of the drilling fluid components are concurrently dispensed into the tank from respective bulk bags under substantially sealed and externally dust-free conditions.

5. A method according to claim 1 wherein the grinding means comprises a pump configured to apply a sheering force to the portion of the mixture circulated through the pump.

6. A method according to claim 5 wherein at least two of the drilling fluid components are concurrently dispensed into the tank from respective bulk bags.

7. A method according to claim 6 wherein each of the components being dispensed from their respective bulk bags into the tank is dispensed at a rate of at least about 2 cubic feet per minute.

8. A method according to claim 7 wherein the rate is at least about 10 cubic feet per minute.

9. A method according to claim 1 wherein steps (a)-(c) are performed on an offshore oil well drilling platform.

10. A method of mixing two or more drilling fluid components to form a drilling fluid composition, the method comprising:
(a) combining the components in a substantially sealed mixing tank to form a mixture, at least one of the drilling fluid components being dispensed under pressure and under substantially sealed and externally dust-free conditions into the tank at a rate of at least about 8 cubic feet per minute, and
(b) agitating the mixture within the mixing tank so that the mixture has an average particle diameter no greater than about 10 times the greater or greatest of the average particle diameters of the drilling fluid components.

11. A method according to claim 10 wherein the rate in (a) is at least about 13 cubic feet per minute.

12. A method according to claim 11 wherein the rate in (a) is at least about 21 cubic feet per minute.

13. A method according to claim 10 wherein steps (a) and (b) are performed on an offshore oil well drilling platform.

14. A method according to claim 10 wherein the method is conducted as a batch process and steps (a) and (b) are conducted in a period of time no greater than about 30 minutes.

15. A method according to claim 14 wherein the period of time is no greater than about 15 minutes.

16. A method according to claim 15 wherein the period of time is no greater than about 10 minutes.

17. A method according to claim 10 wherein the mixture has an average particle diameter no greater than about 4 times the greater or greatest of the average particle diameters of the drilling fluid components.

18. A method according to claim 17 wherein the mixture has an average particle diameter no greater than about 1 times the greater or greatest of the average particle diameters of the drilling fluid components.

19. Apparatus for mixing two or more drilling fluid components at an oil well drill site to produce a drilling fluid composition, the apparatus comprising:
a) a substantially sealed mixing tank;
b) agitating means for agitating a mixture within the mixing tank;
c) at least one receiving means for receiving a bulk bag which contains at least one of the drilling fluid components and for conveying the contents of the bulk bag into the tank, the receiving means being capable of conveying the contents of the bulk bag at a rate of at least about 2 cubic feet per minute; and
d) grinding means for breaking apart agglomerates within the mixture while at least a portion of the mixture circulates through the grinding means.

20. Apparatus according to claim 19 further comprising support means for supporting the bulk bag to be received by the receiving means.

21. Apparatus according to claim 19 wherein the grinding means comprises a pump configured to apply a sheering force to the portion of the mixture circulated through the pump.

22. Apparatus according to claim 19 wherein the agitating means is a motorized blender comprised of a plurality of blades extending radially from an end portion of a substantially vertical drive shaft which extends into the tank.

23. A rig according to claim 19 wherein the tank is cylindrical and is disposed so that its imaginary longitudinal axis is substantially vertical, and wherein the tank comprises an inner surface from which a plurality of substantially vertical baffles extend inwardly toward the imaginary longitudinal axis of the tank.

24. Apparatus according to claim 19 further comprising a plurality of the receiving means for receiving respective bulk bags, each bag containing at least one of the drilling fluid components, and for conveying the contents of the bulk bags into the tank under substantially sealed and externally dust-free conditions.

25. Apparatus according to claim 24 wherein the agitating means is a motorized blender comprised of a plurality of blades extending radially from an end portion of a substantially vertical drive shaft which extends into the tank.

26. Apparatus according to claim 25 wherein the grinding means comprises a pump configured to apply a sheering force to the portion of the mixture circulated through the pump.

27. Apparatus according to claim 26 further comprising support means for supporting the bulk bag to be received by the receiving means.

28. An offshore drilling rig which comprises:
a) a platform suspendable above sea level;
b) a substantially sealed mixing tank;
c) agitating means for agitating a mixture within the mixing tank;
d) at least one receiving means for receiving a bulk bag which contains at least one mixture staring component and for conveying the contents of the bulk bag into the tank, the receiving means being capable of conveying the contents of the bulk bag at a rate of at least 2 cubic feet per minute;
e) grinding means for breaking apart agglomerates within the mixture while at least a portion of the mixture circulates through the grinding means; and
f) a conduit for transporting the mixture from the mixing tank to a desired location.

29. A rig according to claim 28 further comprising support means for supporting the bulk bag to be received by the receiving means.

30. A rig according to claim 28 wherein the grinding means comprises a pump configured to apply a sheering force to the portion of the mixture circulated through the pump.

31. A rig according to claim 28 wherein the agitating means is a motorized blender comprised of a plurality of blades extending radially from an end portion of a substantially vertical drive shaft which extends into the tank.

32. A rig according to claim 28 wherein the tank is cylindrical and is disposed so that its imaginary longitudinal axis is substantially vertical, and wherein the tank comprises an inner surface from which a plurality of substantially vertical baffles extend inwardly toward the imaginary longitudinal axis of the tank.

33. A rig according to claim 28 further comprising a plurality of the receiving means for receiving respective bulk bags, each bag containing at least one mixture starting component, and for conveying the contents of the bulk bags into the tank under substantially sealed and externally dust-free conditions.

34. A rig according to claim 33 wherein the agitating means is a motorized blender comprised of a plurality of blades extending radially from an end portion of a substantially vertical drive shaft which extends into the tank.

35. A rig according to claim 34 wherein the grinding means comprises a pump configured to apply a sheering force to the portion of the mixture circulated through the pump.

36. A rig according to claim 35 further comprising support means for supporting the bulk bag to be received by the receiving means.
